(19) United States
(12) Patent Application Publication
(10) Pub. No.: US 2017/0366925 A1
(43) Pub. Date: Dec. 21, 2017

(54) NFC-BASED COMMUNICATION DEVICE AND METHOD

(71) Applicant: CHINA UNIONPAY CO., LTD., Shanghai (CN)

(72) Inventors: Wei GUO, Shanghai (CN); Dingzhou Ll, Shanghai (CN); Yu ZHOU, Shanghai (CN)

(73) Assignee: CHINA UNIONPAY CO,. LTD., Shanghai (CN)

(21) Appl. No.: 15/532,390

(22) PCT Filed: Dec. 8, 2015
(86) PCT No.: PCT/CN2015/096706

§ 371 Date: Jun. 1, 2017

(30) Foreign Application Priority Data
Dec. 29, 2014 (CN) 201410830958.3

(51) Int. Cl. H04W 4/00; G06F 21/53; H04W 76/02; H04W 8/00

(52) U.S. Cl. CPC H04W 4/008; H04W 76/023; G06F 21/53; H04W 8/005

(57) ABSTRACT

The present invention discloses a NFC-based communication apparatus, comprising: a NFC module set in a trusted execution environment of the communication apparatus, the trusted execution environment being independent of a rich execution environment of the communication apparatus, the NFC module comprises a communication module, which is used for establishing a connection with another NFC apparatus, and a protocol module, which is used for resolving the communication data between the communication apparatus and the another NFC apparatus.

### FIELD OF INVENTION

The present invention relates to NFC communication, and more particularly, to a NFC-based communication apparatus and a method thereof.

### BACKGROUND

The technology of Trusted Execution Environment (TEE) is capable of providing a trusted execution environment guarded by hardware for communication apparatuses such as smart terminals, etc. Under the environment, security related sensitive operations on smart terminals are accomplished based on TEE, thus strengthening the security for data.

The technology of Near Field Communication (NFC) is used for non-contact recognition, such that short distance wireless communication can be performed among mobile devices, consumer electronics, PCs, and smart control tools.

In the prior art, the NFC function is implemented under a rich execution environment (for example, Android, IOS, etc.), which will impair the secure closed loop of the trusted execution environment. For example, the secure payment information, such as financial transactions, etc., need to be transmitted to a secure trusted execution environment via an insecure rich execution environment, during which the sensitive information may be stolen or tampered.

### SUMMARY OF INVENTION

The present invention discloses a NFC-based communication apparatus, comprising: a NFC module set in a trusted execution environment of the communication apparatus, the trusted execution environment being independent of a rich execution environment of the communication apparatus, wherein, the NFC module comprises a communication module, which is used for establishing a connection to another NFC apparatus, and a protocol module, which is used for resolving the communication data between the communication apparatus and the another NFC apparatus.

In one example, the NFC module is used for performing a NFC function of a security related application

In one example, the security related application is an application installed under the trusted execution environment or an application installed under the rich execution environment, and where the security related application is a first application installed under the rich execution environment, the NFC module implements the NFC function of the first application via another application installed under the trusted execution environment corresponding to the first application.

In one example, the communication apparatus further comprises a virtual NFC module set in the rich execution environment, the virtual NFC module is used for simulating the NFC hardware set in the trusted execution environment, such that the NFC function of the application installed under the rich execution environment can be processed by the NFC hardware.

In one example, a NFC routing table is further set in the protocol module, the NFC routing table associates an application ID with the system environment and the application name.

The present invention further discloses a NFC-based communication method, the communication method comprises:

setting a NFC module in a trusted execution environment of the communication apparatus, the trusted execution environment being independent of a rich execution environment of the communication apparatus, wherein,

setting a communication module and a protocol module in the NFC module,

establishing a connection to another NFC apparatus by use of the communication module,

resolving the communication data between the communication apparatus and the another NFC apparatus by use of the protocol module.

In one example, the NFC function of the security related application is performed by use of the NFC module.

In one example, the security related application is an application installed under the trusted execution environment or an application installed under the rich execution environment, and where the security related application is a first application installed under the rich execution environment, the NFC function of the first application is implemented, by use of the NFC module, via another application installed under the trusted execution environment corresponding to the first application.

In one example, the method comprises,

setting a virtual NFC module in the rich execution environment,

simulating the NFC hardware set in the trusted execution environment by use of the virtual NFC module, such that the NFC function of the application installed under the rich execution environment can be processed by the NFC hardware.

In one example, a NFC routing table is further set in the protocol module, the NFC routing table associates an application ID with the system environment and the application name.

The present invention is capable of enhancing the security of NFC communication. By setting a NFC module which implements only part of the traditional protocol stack in the TEE, the storage load of TEE environment is reduced, and the flexibility of NFC communication is increased.

### BRIEF DESCRIPTION OF DRAWINGS

After reading the Description of Embodiments of the invention by reference to the drawings, one skilled in the art may get to know the invention more clearly. It should be understood by one skilled in the art that the drawings are merely used for explaining the technical solution of the invention in coordination with the Description of Embodiments, rather than intended to limit the protecting scope of the invention.

FIG. 1 is a schematic diagram of a NFC-based communication apparatus according to an embodiment of the invention.

FIG. 2 is a schematic diagram of a NFC-based communication apparatus according to another embodiment of the invention.

### DESCRIPTION OF EMBODIMENTS

A further description for the description of embodiments of the invention are made by reference to the drawings hereinafter. It should be understood that modifications on structures and functions may be made to the described embodiments. Moreover, as it may be desired by and advantageous to any given or particular application, one or more characteristics of one embodiment may be combined with one or more characteristics of another embodiment.

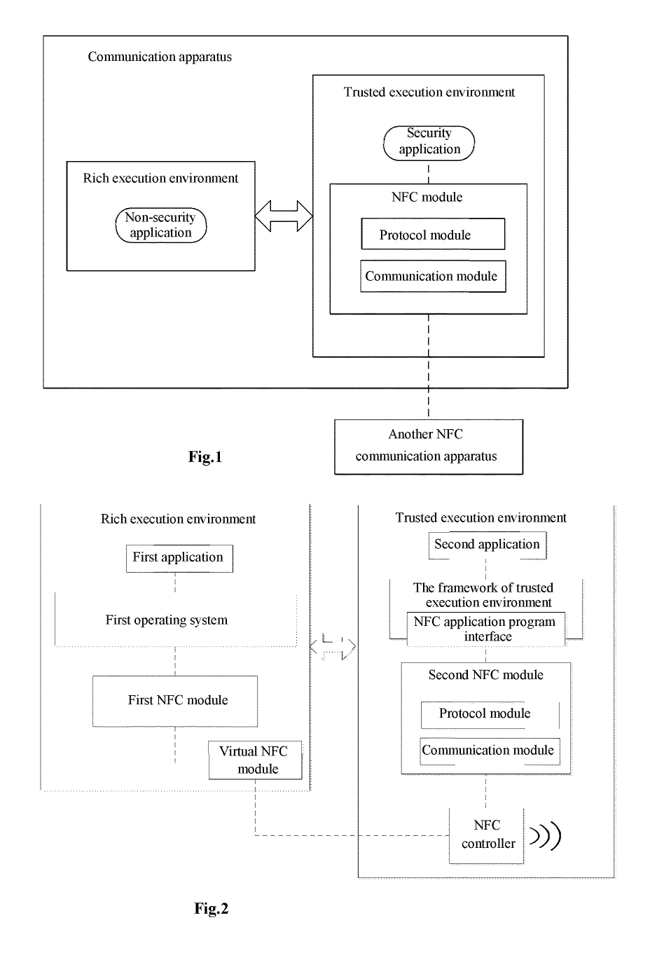

FIG. 1 is a schematic diagram of a NFC-based communication apparatus according to an embodiment of the invention. As showed in the figure, a NFC-based communication apparatus (e.g. a smart mobile communication terminal) comprises a NFC module to implement a NFC function of the communication apparatus. The NFC module is set in a trusted execution environment of the communication apparatus. As showed in the figure, the trusted execution environment is independent of the rich execution environment of the communication apparatus. The trusted execution environment (TEE) may be used for performing a specific application, for example, a security application. The rich execution environment (REE), such as an Android operating system, may be used for performing other applications other than the specific application. Among other things, the NFC module comprises a communication module, which is used for establishing a connection to another NFC apparatus, and a protocol module, which is used for resolving communication data between the communication apparatus and the another NFC apparatus, the protocol module is further used for performing NFC protocols to implement NFC communications. It is understood that the another NFC apparatus in FIG. 1 may be any entity integrated with a NFC function, for example, an IC card, a bank card, a mobile communication device (e.g. a mobile phone), a smart terminal (e.g. a tablet), etc.

FIG. 2 is a schematic diagram of a NFC-based communication apparatus according to another embodiment of the invention. According to the embodiment, a second NFC module set in the trusted execution environment of the communication apparatus may be used for performing a NFC function of a security related application. A security related application is an application installed under the trusted execution environment, such as a second application in FIG. 2, or an application installed under the rich execution environment, such as a first application in FIG. 2. As for the second application, when the NFC function needs to be performed, a NFC application program interface may be employed in the framework of the trusted execution environment such that the second NFC module can be utilized. In that case, the second NFC module may implement the NFC function of the second application via the NFC application program interface in the framework of the trusted execution environment. As for the first NFC application (e.g. the payment application), when a NFC function needs to be performed, another application installed under the trusted execution environment corresponding to the first application may be employed in the framework of the trusted execution environment, then the second NFC module may be utilized by the another application via the NFC application program interface. In that case, the second NFC module may implement the NFC function of the another application via the NFC application program interface in the framework of the trusted execution environment. Herein, the NFC application program interface (API), for example, an API associated with an Open NFC, an NCI protocol, etc., may be customized in accordance with the actual usage.

Continuing with FIG. 2, according to one embodiment of the invention, a virtual NFC module may be set in the rich execution environment, which is used for simulating the NFC hardware set in the trusted execution environment, such that the NFC function of the application installed under the rich execution environment can be processed by the NFC hardware. For example, a regular application (a non-security application) in a first operating system (e.g. an Android system) as showed in the figure may implement the NFC function by utilizing the first NFC module via the NFC application program interface of the first operating system. Herein, the first NFC module may be a traditional NFC module, which implements a NFC traditional protocol stack. When the regular application is about to execute the NFC function, its request is sent to a NFC controller (NFCC), by which the data processing is implemented under the trusted execution environment, via the virtual NFC module.

According to one embodiment of the invention, a NFC routing table may be set in the protocol module, which associates an application ID with the system environment, and the application name. Thus, via the information (including application IDs) transmission by the NFC controller, the protocol module may promptly find the system environment that the application located in (e.g. a rich execution environment, a trusted execution environment, a secure carrier environment), and the application name, improving the efficiency of NFC communication. For example, after the NFC communication information arrives, it is resolved by the protocol module to acquire the application ID, and then the system environment and the application name of the application may be inquired through the NFC routing table, enabling the NFC controller to promptly establish a session with the application. In addition, the protocol module may further update the information in the NFC routing table while the application is updated. Moreover, in addition to the application name and the system environment, the routing table may further associate other factors related to the application with the application ID.

According to one and more other embodiments, the NFC module may further comprise an SE (Security Element) management module for implementing an interaction (for example, data archiving, key storage) between the communication data and the SE (e.g. a SIM card, an SSD card, etc.). The NFC module may further comprise a NFC management module for configuring and managing the NFC controller, for example, enabling and disabling the NFC function, resetting the NFC function, setting the NFC service mode.

According to one or more other embodiments, the protocol module in the NFC module may be used for implementing a reader/writer mode and a card simulating mode, as well as implementing a P2P mode with the traditional NFC protocol stack in the rich execution environment (REE). The NFC module according to the invention may be based on a core protocol stack in a traditional NFC protocol stack architecture. In one example, with the security requirement of the TEE trusted execution environment and the storage status matching the TEE trusted execution environment being accounted for, the NFC protocol stack of the NFC module may be part of the traditional NFC protocol stack architecture.

The protocol module may support both the ISO7816 and the ISO 14443 protocol, the ISO14443 protocol is used for performing the non-contact communication between the NFC module and an external card reader, while the ISO7816 protocol is used for performing the data communication between the NFC module and a terminal SE (such as, a SIM card, an SSD card, etc.).

As described above, the NFC module comprises a communication module, which is used for establishing a connection to another NFC apparatus, and a protocol module, which is used for resolving the communication data between the communication apparatus and the another NFC apparatus. The communication module may further be used for determining a NFC-based communication mode. Several NFC communication mode implemented with the NFC module will be described below as examples.

1. NFC Card Reader Mode

In the mode, the protocol module receives the readable/writable application data through the NFC API from NFC trusted applications on the TEE, and encapsulates the readable/writable application data in accordance with the data format recognizable by the card reader module. Subsequently, the communication module may send the encapsulated data to the NFCC. At last, the encapsulated data is sent through an antenna to an external non-contact card by the NFCC.

2. Card Reader Mode of the REE End

In the mode, the application data forwarded from REE is received at a NFCC of the TEE end, and the received application data is sent by the NFCC through an antenna to an external non-contact card after being processed. Herein, the application data forwarded from the REE may be generated by non-security applications in an Android system, the application data may be encapsulated by the protocol stack at the REE end, and forwarded to the NFCC for being processed via a virtual NFC module.

3. NFC Card Simulating Mode

In the mode, the communication module receives the data sent from the external card reader with the NFCC, and the protocol module may search the respective application through the NFC routing table according to the application ID contained in the data. Then the protocol module will resolve the data sent by the card reader in accordance with the data format recognizable by the card simulating. Optionally, when a request from the card reader requires the participation of an SE, the request may be sent to the respective SE through the SE management module, subsequently, the result is fed back to the external card reader through the SE management module.

4. NFC P2P Mode

In the mode, a connection may be established between two NFC devices in such a manner as follows. First, a NFC communication request sent from an external NFC device is received by the NFCC, the request is resolved by the protocol module in the NFC module. Upon determining the request to pertain to the P2P mode, the protocol module forwards the request to a virtual NFC module in the REE. The request is then forwarded to a traditional NFC protocol stack in the REE by the virtual NFC module. The traditional protocol stack processes the request to establish a connection between two NFC devices.

According to the above disclosure, one or more functions or steps described above implemented by modules may be implemented in one or more steps of the methods according to the embodiments of the present invention.

The present invention further discloses a NFC-based communication method, comprising: setting a NFC module in the trusted execution environment of the communication apparatus, the trusted execution environment being independent of a rich execution environment of the communication apparatus, wherein, setting a communication module and a protocol module in the NFC module, establishing a connection to another NFC apparatus by use of the communication module, and resolving the communication data between the communication apparatus and the another NFC apparatus by use of the protocol modules.

In one example, the NFC function of a security related application is performed by use of the NFC module.

In one example, the security related application is an application installed under the trusted executing environment or an application installed under the rich executing environment, and where the security related application is a first application installed under the rich executing environment, the NFC function of the first application is implement, by use of the NFC module, via another application installed under the trusted executing environment corresponding to the first application.

In one example, the method further comprises, setting a virtual NFC module in the rich execution environment, simulating the NFC hardware set in the trusted execution environment by use of the virtual NFC module, such that the NFC function of the application installed under the rich execution environment can be processed by the NFC hardware.

In one example, a NFC routing table is further set in the protocol module, the NFC routing table associates an application ID with the system environment and the application name.

With the above description of the embodiments, an ordinary skill in the art may understand, various changes and alternatives may also be made to the description of embodiments of the present invention, without departing from the spirit and scope of the invention. All of the changes and alternatives fall within the scope limited by the claims of the invention.

1. A NFC-based communication apparatus, wherein the communication apparatus comprises:
a NFC module set in a trusted execution environment of the communication apparatus, the trusted execution environment being independent of a rich execution environment of the communication apparatus, wherein,
the NFC module comprises a communication module and a protocol module,
the communication module is used for establishing a connection to another NFC apparatus,
the protocol module is used for resolving the communication data between the communication apparatus and the another NFC apparatus.

2. The communication apparatus of claim 1, wherein, the NFC module is used for performing a NFC function of a security related application.

3. The communication apparatus of claim 2, wherein, the security related application is an application installed under the trusted execution environment or an application installed under the rich execution environment, and
where the security related application is a first application installed under the rich execution environment, the NFC module implements the NFC function of the first application via another application installed under the trusted execution environment corresponding to the first application.

4. The communication apparatus of claim 2, wherein the communication apparatus further comprises:
a virtual NFC module set in the rich execution environment, the virtual NFC module is used for simulating the NFC hardware set in the trusted execution environment, such that the NFC function of the application installed under the rich execution environment can be processed by the NFC hardware.

5. The communication apparatus of claim 1, wherein,
a NFC routing table is further set in the protocol module, the NFC routing table associates an application ID with the system environment and the application name.

6. A NFC-based communication method, wherein the communication method comprises:
setting a NFC module in a trusted execution environment of the communication apparatus, the trusted execution environment being independent of a rich execution environment of the communication apparatus, wherein,
setting a communication module and a protocol module in the NFC module,
establishing a connection to another NFC apparatus by use of the communication module,
resolving the communication data between the communication apparatus and the another NFC apparatus by use of the protocol module.

7. The communication method of claim 1, wherein, a NFC function of the security related application is performed by use of the NFC module.

8. The communication method of claim 2, wherein the security related application is an application installed under a trusted execution environment or an application installed under a rich execution environment, and
where the security related application is a first application installed under the rich execution environment, the NFC function of the first application is implemented, by use of the NFC module, via another application installed under the trusted execution environment corresponding to the first application.

9. The communication method of claim 2, wherein, the communication method further comprises,
setting a virtual NFC module in the rich execution environment,
simulating the NFC hardware set in the trusted execution environment by use of the virtual NFC module, such that the NFC function of the application installed under the rich execution environment can be processed by the NFC hardware.

10. The communication method of claim 1, wherein,
a NFC routing table is further set in the protocol module, the NFC routing table associates an application ID with the system environment and the application name.
